(19) United States
(12) Patent Application Publication
(10) Pub. No.: US 2026/0205892 A1
(43) Pub. Date: Jul. 16, 2026

(54) METHOD, DEVICE AND COMPUTER STORAGE MEDIUM OF COMMUNICATION

(71) Applicant: NEC Corporation, Tokyo (JP)

(72) Inventor: Gang WANG, Beijing (CN)

(73) Assignee: NEC Corporation, Tokyo (JP)

(21) Appl. No.: 19/135,497

(22) PCT Filed: Dec. 6, 2022
(86) PCT No.: PCT/CN2022/137010

§ 371 Date: Jun. 4, 2025

(51) Int. Cl. H04W 36/00; H04L 12/18; H04W 36/08; H04W 88/08

(52) U.S. Cl. CPC H04W 36/0009; H04L 12/1868; H04W 36/0072; H04W 36/087; H04W 88/085

(57) ABSTRACT

Embodiments of the present disclosure relate to methods, devices and computer readable media for communication. A terminal device receives, from a network device, a configuration indicating a predetermined resource for transmission of an acknowledgement for a command, the command being for a group of terminal devices comprising the terminal device. Upon reception of the command from the network device, the terminal device transmits, via the predetermined resource, the acknowledgement for the command. In this way, a mechanism to acknowledge a command for a group of terminal devices is provided.

### TECHNICAL FIELD

Embodiments of the present disclosure generally relate to the field of telecommunication, and in particular, to methods, devices and computer storage media of communication for a group of terminal devices.

### BACKGROUND

Recently, a work item for mobile integrated access and backhaul (IAB) is ongoing. It has been proposed that mobile IAB should focus on a scenario of a mobile IAB node mounted on a vehicle providing the fifth generation (5G) coverage or capacity enhancement to an on-board terminal device and a surrounding terminal device. In this scenario, the on-board terminal device moves together with the mobile IAB node. When the mobile IAB node performs inter-donor full migration (i.e., a donor central unit (CU) of the mobile IAB node is changed), a group of terminal devices connected to the mobile IAB node needs to perform group mobility together with the mobile IAB node. However, it is still unclear how to perform the group mobility for the group of terminal devices.

### SUMMARY

In general, embodiments of the present disclosure provide methods, devices and computer storage media of communication for a group of terminal devices.

In a first aspect, there is provided a method of communication. The method comprises: receiving, at a terminal device and from a network device, a configuration indicating a predetermined resource for transmission of an acknowledgement for a command, the command being for a group of terminal devices comprising the terminal device; receiving the command from the network device; and transmitting, via the predetermined resource, the acknowledgement for the command.

In a second aspect, there is provided a method of communication. The method comprises: transmitting, at a network device and to a terminal device, a configuration indicating a predetermined resource for transmission of an acknowledgement for a command, the command being for a group of terminal devices comprising the terminal device.

In a third aspect, there is provided a method of communication. The method comprises: receiving, at a network device and from a terminal device, an acknowledgement for a command via a predetermined resource for the acknowledgement, the command being for a group of terminal devices comprising the terminal device and indicating a handover of the group of terminal devices to a target cell provided by the network device.

In a fourth aspect, there is provided a device of communication. The device comprises a processor configured to cause the device to perform the method according to any of the first to third aspects of the present disclosure.

In a fifth aspect, there is provided a computer readable medium having instructions stored thereon. The instructions, when executed on at least one processor, cause the at least one processor to perform the method according to any of the first to third aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a CU/distributed unit (DU) architecture in which some embodiments of the present disclosure can be implemented;

FIG. 2 illustrates a schematic diagram illustrating an example process of communication according to embodiments of the present disclosure;

FIG. 3 illustrates a schematic diagram illustrating another example process of communication according to embodiments of the present disclosure;

FIG. 4 illustrates a schematic diagram illustrating an example process of communication in an intra-CU scenario according to embodiments of the present disclosure;

FIG. 5 illustrates a schematic diagram illustrating an example process of communication in an inter-CU scenario according to embodiments of the present disclosure;

FIG. 6 illustrates an example method of communication implemented at a terminal device in accordance with some embodiments of the present disclosure;

FIG. 7 illustrates an example method of communication implemented at a network device in accordance with some embodiments of the present disclosure;

FIG. 8 illustrates another example method of communication implemented at a network device in accordance with some embodiments of the present disclosure; and

FIG. 9 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, when a mobile IAB node performs inter-donor full migration, a group of terminal devices connected to the mobile IAB node needs to perform group mobility together with the mobile IAB node. Conventionally, full migration may require RRCReconfiguration messages to be sent almost at the same time to all connected terminal devices, which may cause congestion during a handover of served terminal devices. Full migration may lead to handover of terminal devices in bulk within a short time duration, which make random access conflict and all served terminal devices transmit RRCReconfigurationComplete messages in a short time and thus cause congestion.

In view of this, embodiments of the present disclosure provide a solution of communication for a group of terminal devices so as to overcome the above issue and other potential issues. In the solution, a network device transmits, to a terminal device, a configuration indicating a predetermined resource for transmission of an acknowledgement for a command, the command being for a group of terminal devices comprising the terminal device. Upon reception of the command from the network device, the terminal device transmits the acknowledgement for the command via the predetermined resource.

In this way, a mechanism to acknowledge a command for a group of terminal devices is provided. Accordingly, a network may know whether a terminal device receives the command. Comparing with 1 to 1 command/acknowledge procedure, the present mechanism may reduce signaling overhead as it does not need to transmit an individual command to each terminal device. In addition, as a resource for acknowledgement is preconfigured and is specific to a terminal device, signaling congestion may be avoided.

Principles and implementations of the present disclosure will be described in detail below with reference to the figures.

### Example of Communication Network

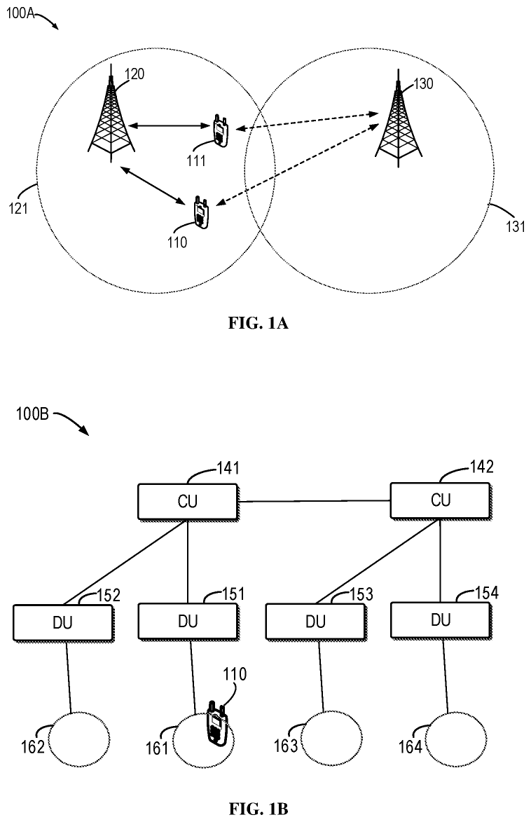

FIG. 1A illustrates a schematic diagram of an example communication network 100A in which some embodiments of the present disclosure can be implemented. As shown in FIG. 1A, the communication network 100A may include terminal devices 110 and 111 and network devices 120 and 130. The network devices 120 and 130 provide respective cells 121 and 131 to serve one or more terminal devices. In this example of FIG. 1A, the terminal devices 110 and 111 are located in the cell 121 and are served by the network device 120.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for serving one or more terminal devices therein.

As shown in FIG. 1A, the terminal device 110 or 111 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 or 111 towards the network device 120 or 130 is referred to as uplink (UL) communication, while communication in a reverse direction from the network device 120 or 130 towards the terminal device 110 is referred to as downlink (DL) communication. The terminal device 110 or 111 can move amongst the cells of the network devices 120, 130 and possibly other network devices. In UL communication, the terminal device 110 or 111 may transmit UL data and control information to the network device 120 or 130 via a UL channel. In DL communication, the network device 120 or 130 may transmit DL data and control information to the terminal device 110 or 111 via a DL channel.

FIG. 1B illustrates a schematic diagram 100B of a CU/DU architecture in which some embodiments of the present disclosure can be implemented. The CU/DU architecture may be established at a network device (e.g., the network device 120 or 130).

In the context of the present application, a CU (also referred to as a gNB-CU herein) is a logic node hosting a radio resource control (RRC), a service data application protocol (SDAP) and a packet data convergence protocol (PDCP) layers of a gNB or RRC and PDCP layers of an en-gNB that controls operation of one or more DUs (also referred to as gNB-DUs herein). The gNB-CU terminates a F1 interface connected with the gNB-DU. A DU is a logical node hosting radio link control (RLC), medium access control (MAC) and physical (PHY) layers of the gNB or en-gNB, and its operation is partly controlled by gNB-CU. One gNB-DU supports one or multiple cells. One cell is supported by only one gNB-DU. The gNB-DU terminates a F1 interface connected with the gNB-CU.

As shown in FIG. 1B, CUs 141 and 142 are shown. It is to be understood that more or less CUs may be comprised. Each of the CUs 141 and 142 may communicate with one or more DUs. Here, a DU 151 and a DU 152 are shown as communicating with the CU 141 and a DU 153 and a DU 154 are shown as communicating with the CU 142. It is to be understood that more or less DUs may also be provided for implementation of embodiments of the present disclosure. Although not shown, the CU 141 may be responsible for accomplishing the functionalities of the SDAP entity and the PDCP entity, and the DU 151 or 152 may be responsible for accomplishing the functionalities of the RLC entity, the MAC entity and the PHY entity. The CU 142 may be responsible for accomplishing the functionalities of the SDAP entity and the PDCP entity, and the DU 153 or 154 may be responsible for accomplishing the functionalities of the RLC entity, the MAC entity and the PHY entity.

Each of the DUs 151 to 154 may provide one or more cells. For convenience, the DU 151, 152, 153, and 154 is shown as providing a cell 161, 162, 163 and 164 respectively. It is to be understood that this is merely an example, and more cells are also feasible. The terminal device 110 or 111 may communicate with any of these cells.

In some embodiments, the terminal device 110 or 111 may switch from one cell to another cell under control of the same CU. For example, the terminal device 110 or 111 may be handed over from one cell 161 to another cell 162. This is called as an intra-CU handover. In some embodiments, the DU 151 and the DU 152 may be the same DU. In some embodiments, the DU 151 and the DU 152 may be different DUs.

In some embodiments, the terminal device 110 or 111 may switch from one cell to another cell under control of different CUs. For example, the terminal device 110 or 111 may be handed over from one cell 161 to another cell 163. This is called as an inter-CU handover.

In some embodiments, the network device 120 and the network device 130 may correspond to one or two devices under the same CU. In some embodiments, the network device 120 and the network device 130 may correspond to one or two devices under the different CUs. In some embodiments, a CU and a DU may be implemented in separate devices. In some embodiments, a CU and a DU may be implemented in the same device. In some embodiments, different DUs may be implemented in separate devices.

Returning to FIG. 1A, in some embodiments, the network device 120 may issue a command for a group of terminal devices (for example, for both the terminal devices 110 and 111). For convenience, the command for the group of terminal devices may also be referred to as a group command herein. In some embodiments, the group command may be a multicast or broadcast signaling. In some embodiments, the group command may be a handover command. The handover command may indicate handover of the group of terminal devices from one cell to another cell. For example, a mobile IAB node in a vehicle may transmit a handover command to a group of on-board terminal devices, and the group of on-board terminal devices may perform an intra-CU or inter-CU handover based on the handover command. However, implementation of acknowledgement for the group command is still incomplete.

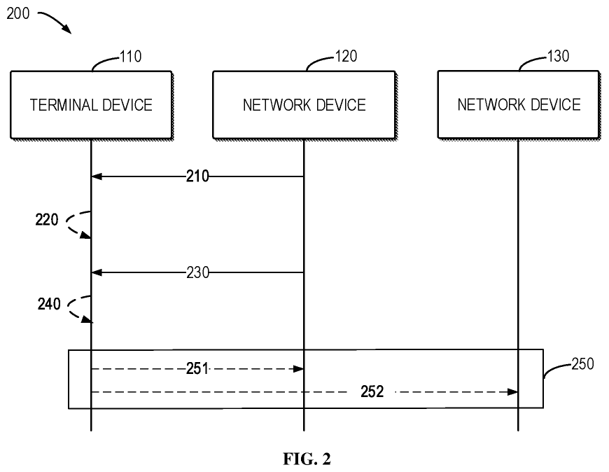

In view of this, embodiments of the present disclosure provide a solution of acknowledging a group command to overcome the above and other potential issues. The solution will be described in detail with reference to FIGS. 2 to 5 below.

### Example Implementation of Acknowledgement for Group Command

FIG. 2 illustrates a schematic diagram illustrating an example process 200 of communication according to embodiments of the present disclosure. For the purpose of discussion, the process 200 will be described with reference to FIG. 1A. The process 200 may involve the terminal device 110 and the network devices 120 and 130 as illustrated in FIG. 1A. It is to be understood that the same process also applies to the terminal device 111.

As shown in FIG. 2, the network device 120 may transmit 210, to the terminal device 110, a configuration for a command (i.e., a group command) for a group of terminal devices (e.g., the terminal devices 110 and 111). In some embodiments, the network device 120 may transmit the configuration via an RRC message, e.g., an RRCSetup message or an RRCResume message or an RRCReconfiguration message.

In some embodiments, the configuration for the command may comprise a configuration indicating a predetermined resource for transmission of an acknowledgement for the command. In some embodiments, the predetermined resource may be non-periodic, e.g., one-shot. In some embodiments, the predetermined resource may be periodic. In some embodiments, the predetermined resource may be deactivated by default, and may be activated when the command for the group of terminal devices is received.

In some embodiments, the predetermined resource may comprise at least one of a preamble or a random access resource specific to the terminal device 110. In some embodiments, the predetermined resource may comprise a resource for a scheduling request (SR). In some embodiments, the predetermined resource may comprise a resource for a physical uplink control channel (PUCCH) transmission. In some embodiments, the predetermined resource may comprise a resource for a sounding reference signal (SRS). In some embodiments, the predetermined resource may comprise a resource for a physical uplink shared channel (PUSCH) transmission, e.g., an uplink grant. It is to be understood that the predetermined resource may comprise any combination of the above resources or any other suitable resources.

In some embodiments, the configuration for the command may comprise a further configuration for performance of the command. For example, the further configuration may indicate how to receive and apply the command. It is to be understood that the configuration for the command may comprise any other suitable information, and the present disclosure does not limit this aspect.

Continue to refer to FIG. 2, the terminal device 110 may store 220 the configuration for the command. It is to be understood that the configuration for the command may be stored in any suitable ways.

When the network device 120 determines to trigger a group common signaling, the network device 120 may transmit 230, to the group of terminal devices, the command for the group of terminal devices.

In some embodiments, the network device 120 may transmit a layer 1 (L1) or layer 2 (L2) signaling indicating the command. For example, the network device 120 may transmit downlink control information (DCI) indicating the command. In another example, the network device 120 may transmit a medium access control control element (MAC CE) indicating the command.

In some embodiments, the network device 120 may transmit a short message indicating the command. In some embodiments, the network device 120 may transmit a paging message indicating the command. In some embodiments, the network device 120 may transmit a system information block (SIB) indicating the command. In some embodiments, the network device 120 may transmit a multicast or broadcast RRC signaling indicating the command. In some embodiments, the network device 120 may transmit a low-power wake-up signal (LP WUS) indicating the command. In some embodiments, the network device 120 may transmit a paging early indication (PEI) indicating the command. It is to be understood that any other suitable ways are also feasible for transmission of the group command.

With reference to FIG. 2, upon reception of the group command, the terminal device 110 may apply 240 the stored configuration for the group command. The terminal device 110 may transmit 250 the acknowledgement for the group command via the predetermined resource configured for the terminal device 110.

In some embodiments, the terminal device 110 may transmit, via the predetermined resource, a preamble specific to the terminal device 110 as the acknowledgement for the group command. For example, the preamble may be transmitted on a specific random access resource.

In some embodiments, the terminal device 110 may transmit, via the predetermined resource, a SR as the acknowledgement for the group command. In some embodiments, the terminal device 110 may transmit, via the predetermined resource, a positive acknowledgement (ACK) or a negative acknowledgement (NACK) as the acknowledgement for the group command. For example, the SR or ACK/NACK may be carried via a PUCCH transmission.

In some embodiments, the terminal device 110 may transmit, via the predetermined resource, a SRS as the acknowledgement for the group command. In some embodiments, the terminal device 110 may transmit, via the predetermined resource, a MAC CE as the acknowledgement for the group command. For example, the MAC CE may be transmitted as a PUSCH transmission on a pre-allocated uplink grant.

In some embodiments, the terminal device 110 may transmit, via the predetermined resource, a RRC message as the acknowledgement for the group command. For example, the RRC message such as an RRCReconfigurationComplete message may be transmitted on a pre-allocated uplink grant.

It is to be understood that any other suitable ways are also feasible for transmission of the acknowledgement for the group command.

In some embodiments where the command is a multicast or broadcast signaling, the terminal device 110 may transmit 251 the acknowledgement to the network device 120. In some embodiments, the command may be a handover command (for convenience, also referred to as a group handover command herein) for the group of terminal devices. In this case, the terminal device 110 may transmit 252 the acknowledgement to a further network device (e.g., the network device 130) as a target device of the handover.

With the process 200, a mechanism to acknowledge a command for a group of terminal devices is provided. As a resource for acknowledgement is preconfigured and is specific to a terminal device, signaling congestion may be avoided.

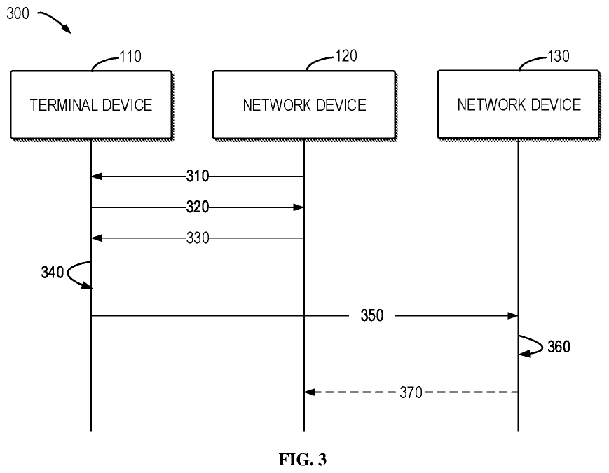

For illustration, an example acknowledgement for a group handover command will be further described with reference to FIG. 3.

### Example Implementation of Acknowledgement for Group Handover Command

FIG. 3 illustrates a schematic diagram illustrating an example process 300 of communication according to embodiments of the present disclosure. For the purpose of discussion, the process 300 will be described with reference to FIG. 1A. The process 300 may involve the terminal device 110 and the network devices 120 and 130 as illustrated in FIG. 1A. It is to be understood that the same process also applies to the terminal device 111. In this example, the network device 120 serves as a source gNB providing a source cell (e.g., the cell 121), and the network device 130 serves as a target gNB providing a target cell (e.g., the cell 131).

As shown in FIG. 3, the network device 120 may transmit 310, to the terminal device 110, a configuration for a handover command (i.e., a group handover command) for a group of terminal devices (e.g., the terminal devices 110 and 111). In some embodiments, the network device 120 may transmit the configuration via an RRC message, e.g., an RRCSetup message or an RRCResume message or an RRCReconfiguration message.

In some embodiments, the configuration for the handover command may comprise a configuration indicating a predetermined resource for transmission of an acknowledgement for the handover command. In some embodiments, the predetermined resource may be non-periodic, e.g., one-shot. In some embodiments, the predetermined resource may be periodic. In some embodiments, the predetermined resource may be deactivated by default, and may be activated when the handover command for the group of terminal devices is received.

In some embodiments where the predetermined resource is non-periodic, the configuration for the handover command may comprise a predefined timing offset after the handover command is received.

In some embodiments, the predetermined resource may comprise at least one of a preamble or a random access resource specific to the terminal device 110. In some embodiments, the predetermined resource may comprise a resource for a SR. In some embodiments, the predetermined resource may comprise a resource for a PUCCH transmission. In some embodiments, the predetermined resource may comprise a resource for a SRS. In some embodiments, the predetermined resource may comprise a resource for a PUSCH transmission, e.g., an uplink grant. It is to be understood that the predetermined resource may comprise any combination of the above resources or any other suitable resources.

In some embodiments, the configuration for the handover command may comprise a further configuration for performance of the handover command. That is, the further configuration may indicate how to receive and apply the handover command.

In some embodiments, the further configuration may comprise a set of candidate cells for the handover of the group of terminal devices. In some embodiments, the further configuration may comprise an indication indicating whether a random access procedure is performed for the handover to a candidate cell in the set of candidate cells. That is, the indication indicates whether a random access channel (RACH)-less handover is performed. Alternatively, the further configuration may comprise an indication indicating whether current timing advance (TA) is still valid in a target cell. In some embodiments, the further configuration may comprise an indication indicating whether an update of a security key is performed for the handover to the candidate cell.

In some embodiments, the configuration for the handover command may comprise a set of execution conditions for the handover. In some embodiments, the set of execution conditions may be triggered by a source cell (i.e., the network device 120). That is, the network device 120 may determine whether the set of execution conditions is satisfied, and may determine to trigger the group handover command if the set of execution conditions is satisfied.

It is to be understood that the configuration for the handover command may comprise any other suitable information, and the present disclosure does not limit this aspect.

In some embodiments, the terminal device 110 may store the configuration for the handover command. It is to be understood that the configuration for the handover command may be stored in any suitable ways. Continue to refer to FIG. 3, upon reception of the configuration for the handover command, the terminal device 110 may transmit 320 an RRCReconfigurationComplete message to the network device 120.

When the network device 120 determines to trigger a group handover command, the network device 120 may transmit 330, to the group of terminal devices, the group handover command for the group of terminal devices.

In some embodiments, the network device 120 may transmit a L1 or L2 signaling indicating the group handover command. For example, the network device 120 may transmit DCI indicating the group handover command. In another example, the network device 120 may transmit a MAC CE indicating the group handover command.

In some embodiments, the network device 120 may transmit a short message indicating the group handover command. In some embodiments, the network device 120 may transmit a paging message indicating the group handover command. In some embodiments, the network device 120 may transmit a SIB indicating the group handover command. In some embodiments, the network device 120 may transmit a multicast or broadcast RRC signaling indicating the group handover command. In some embodiments, the network device 120 may transmit a LP WUS indicating the group handover command. In some embodiments, the network device 120 may transmit a PEI indicating the group handover command. It is to be understood that any other suitable ways are also feasible for transmission of the group handover command.

In some embodiments, the group handover command may comprise an indication that the handover is triggered. In some embodiments, the group handover command may comprise information of the target cell. In some embodiments, the group handover command may comprise an indication indicating whether a TA value for the source cell is valid in the target cell. In some embodiments, the group handover command may comprise an indication indicating whether an update of a security key is performed for the target cell. It is to be understood that the group handover command may comprise any combination of the above information or any other suitable information.

With reference to FIG. 3, upon reception of the group handover command, the terminal device 110 may apply 340 the stored configuration for the group handover command.

For example, the terminal device 110 may maintain a connection with the network device 120 upon reception of the configuration for the group handover command, and start monitoring the group handover command. If the group handover command is received from the network device 120, the terminal device 110 may detach from the network device 120, apply the stored configuration for a target cell (e.g., the cell 131) indicated by the group handover command, synchronize to the target cell, and complete the group handover procedure by sending an acknowledge for the group handover command to the network device 130.

In some embodiments, if a RACH-less handover is configured or an indication that a TA value for the source cell is valid in the target cell is received, the terminal device 110 may synchronize to the target cell without performing random access. Otherwise, random access may be performed to synchronize to the network device 130 (i.e., the target gNB). If a RACH-less handover is configured or an indication that a TA value for the source cell is valid in the target cell is received, and a preamble or RACH resource is configured for acknowledgement for a group handover command, the terminal device 110 may not monitor PDCCH for a random access response (RAR) after sending the acknowledgement.

In some embodiments, if security key update is configured or an indication of security key update is received, the terminal device 110 may perform security key update upon reception of the group handover command.

Continue to refer to FIG. 3, to confirm the handover, the terminal device 110 may transmit 350, to the network device 130, the acknowledgement for the group command via the predetermined resource configured for the terminal device 110. In some embodiments, the terminal device 110 may release the stored configuration for the group handover command upon successful completion of the handover procedure.

In some embodiments, the terminal device 110 may transmit, via the predetermined resource, a preamble specific to the terminal device 110 as the acknowledgement for the group handover command. For example, the preamble may be transmitted on a specific random access resource.

In some embodiments, the terminal device 110 may transmit, via the predetermined resource, a SR as the acknowledgement for the group handover command. In some embodiments, the terminal device 110 may transmit, via the predetermined resource, an ACK or NACK as the acknowledgement for the group handover command. For example, the SR or ACK/NACK may be carried via a PUCCH transmission.

In some embodiments, the terminal device 110 may transmit, via the predetermined resource, a SRS as the acknowledgement for the group handover command. In some embodiments, the terminal device 110 may transmit, via the predetermined resource, a MAC CE as the acknowledgement for the group handover command. For example, the MAC CE may be transmitted as a PUSCH transmission on a pre-allocated uplink grant. An uplink buffer status report, and/or UL data may be sent along with the MAC CE to the network device 130 (i.e., the target gNB). The PUSCH transmission itself received on the pre-allocated uplink grant may be considered as the acknowledgement.

In some embodiments, the terminal device 110 may transmit, via the predetermined resource, a RRC message as the acknowledgement for the group handover command. For example, the RRC message such as an RRCReconfigurationComplete message may be transmitted on a pre-allocated uplink grant. An uplink buffer status report, and/or UL data may be sent along with the RRCReconfigurationComplete message to the network device 130 (i.e., the target gNB).

It is to be understood that any other suitable ways are also feasible for transmission of the acknowledgement for the group handover command.

In some embodiments, if RACH resource or PUCCH resource is configured for acknowledgment, multiple terminal devices may be multiplexed in the same timing or frequency resource, thus reducing the overhead of acknowledgment(s).

In some embodiments, if PUCCH resource is configured for acknowledgment, and ACK/NACK for Group Handover Acknowledgment and ACK/NACK for unicast data are transmitted at the same time, they may be multiplexed and transmitted on the same resource.

In some embodiments, if the terminal device 110 does not get the pre-allocated uplink grant in the configuration (e.g., RRCReconfiguration) for the group handover command, the terminal device 110 may receive an uplink grant via the PDCCH of the target cell. The terminal device 110 may use the first available uplink grant after synchronization to the target cell.

In some embodiments, a timer may be configured for a group handover. The terminal device 110 may be expected to transmit the acknowledgement before the timer expires. In some embodiments, upon reception of the group handover command, the terminal device 110 may start the timer.

In some embodiments, if the acknowledgement is transmitted, the terminal device 110 may stop the timer, and deactivate the predetermined resource. In some embodiments, if a message indicating a handover for the terminal device 110 is received, for example, if an RRCReconfiguration message including reconfigurationWithSync for a master cell group (MCG) is received, the terminal device 110 may stop the timer, and deactivate the predetermined resource. In these embodiments, the terminal device 110 may release a stored configuration for the group handover command. Alternatively, the terminal device 110 may not release the stored configuration for the group handover command.

In some embodiments, if the timer expires, the terminal device 110 may deactivate the predetermined resource, and apply a configuration used in the source cell (e.g., revert back to a configuration used in a source primary cell (PCell)). In these embodiments, the terminal device 110 may release a stored configuration for the group handover command. Alternatively, the terminal device 110 may not release the stored configuration for the group handover command. For example, the timer may be described as shown in Table 1 below.

| Timer | Start | Stop | At expiry |
|---|---|---|---|
| Txxx | Upon reception | Upon successful | Stop the |
| | of the Group | transmission of the | transmission of |
| | Handover | Group Handover | Group Handover |
| | Command. | Acknowledge. | Acknowledge, and |
| | | Upon reception of | initiate the group |
| | | RRCReconfiguration | handover failure |
| | | message including | procedure (e.g., |
| | | reconfigurationWithSync | trigger legacy |
| | | for the MCG. | handover). |

Continue to refer to FIG. 3, upon reception of the acknowledgement for the group handover command, the network device 130 (i.e., target gNB) may know 360 whether the terminal device 110 successfully receives the group handover command. If the acknowledgement is not successfully received or NACK is received, the network device 130 may inform 370 the network device 120 (i.e., source gNB) to trigger a legacy handover procedure (i.e., a handover for a single terminal device).

With the process 300, a mechanism to acknowledge a handover command for a group of terminal devices is provided. As a resource for acknowledgement is preconfigured and is specific to a terminal device, signaling congestion may be avoided.

For illustration, some example embodiments of acknowledgement for a group handover command will be further described in connection with Embodiments 1 and 2.

### Embodiment 1

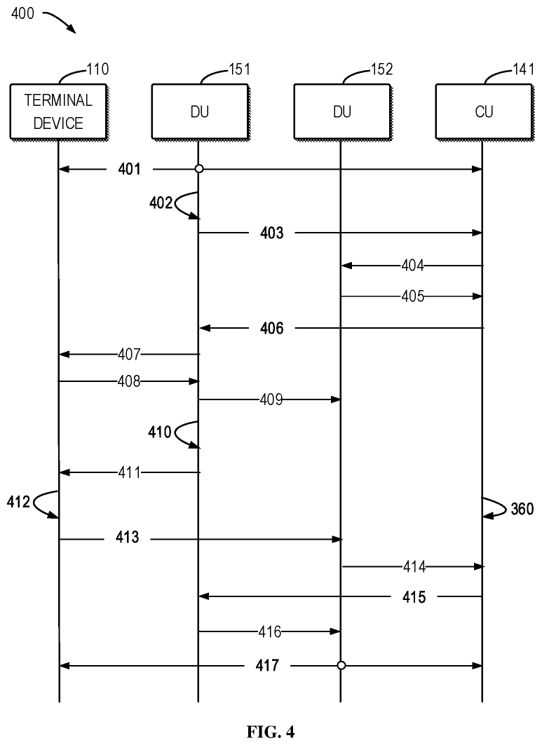

In this embodiment, an intra-CU group handover procedure is described with reference to FIG. 4.

FIG. 4 illustrates a schematic diagram illustrating an example process 400 of communication in an intra-CU scenario according to embodiments of the present disclosure. For the purpose of discussion, the process 400 will be described with reference to FIG. 1B. The process 400 may involve the terminal device 110, the DUs 151 and 152 and the CU 141 as illustrated in FIG. 1B. It is to be understood that the same process also applies to the terminal device 111. In this example, the DU 151 serves as a source DU providing a source cell (e.g., the cell 161), and the DU 152 serves as a target DU providing a target cell (e.g., the cell 162).

As shown in FIG. 4, the terminal device 110 may perform 401 downlink and uplink user data transmission with the CU 141 via the DU 151. In some scenarios, the DU 151 may make 402 a decision of a group handover to the DU 152. The DU 151 may transmit 403, to the CU 141, a handover request for the group handover. The CU 141 may transmit 404, to the DU 152, a UE CONTEXT SETUP REQUEST message comprising conditional inter-DU mobility information. The DU 152 may transmit 405, to the CU 141, a UE CONTEXT SETUP RESPONSE message comprising a requested target cell identity (ID). The CU 141 may transmit 406, to the DU 151, a DL RRC MESSAGE TRANSFER message comprising an RRCReconfiguration message.

The DU 151 may transmit 407, to a group of terminal devices (e.g., the terminal device 110), an RRCReconfiguration message comprising a configuration of a group handover command. This step 407 corresponds to step 310 as described in FIG. 3, and thus is not repeated here for concise. The terminal device 110 may transmit 408 an RRCReconfigurationComplete message to the DU 151. This step 408 corresponds to step 320 as described in FIG. 3, and thus is not repeated here for concise.

The DU 151 may perform 409 an early status transfer to the DU 152. The DU 151 may determine 410 to trigger a group handover. The DU 151 may transmit 411 a group handover command to the group of terminal devices. This step 411 corresponds to step 330 as described in FIG. 3, and thus is not repeated here for concise.

The terminal device 110 may apply 412 the stored configuration for the group handover command. This step 412 corresponds to step 340 as described in FIG. 3, and thus is not repeated here for concise.

Then the terminal device 110 may transmit 413 the acknowledgement for the group command to the DU 152. This step 413 corresponds to step 350 as described in FIG. 3, and thus is not repeated here for concise.

The DU 152 may transmit 414, to the CU 141, an UL RRC MESSAGE TRANSFER message comprising a handover complete message. The DU 152 may inform 415 the DU 151 of the handover success. The DU 151 may perform 416 a serial number (SN) status transfer to the DU 152. Then the terminal device 110 may perform 417 downlink and uplink user data transmission with the CU 141 via the DU 152.

It is to be understood that other details of the process 400 are similar to that of the process 300, and thus are omitted here.

With the process 400, a mechanism to acknowledge a handover command for a group of terminal devices in an intra-CU scenario is provided. As a resource for acknowledgement is preconfigured and is specific to a terminal device, signaling congestion may be avoided.

### Embodiment 2

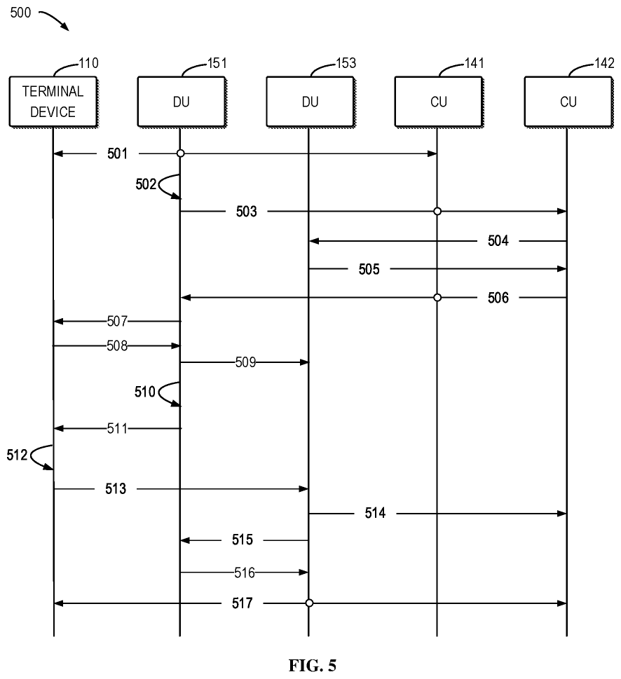

In this embodiment, an inter-CU group handover procedure is described with reference to FIG. 5.

FIG. 5 illustrates a schematic diagram illustrating an example process 500 of communication in an inter-CU scenario according to embodiments of the present disclosure. For the purpose of discussion, the process 500 will be described with reference to FIG. 1B. The process 500 may involve the terminal device 110, the DUs 151 and 153 and the CUs 141 and 142 as illustrated in FIG. 1B. It is to be understood that the same process also applies to the terminal device 111. In this example, the DU 151 serves as a source DU providing a source cell (e.g., the cell 161), and the DU 153 serves as a target DU providing a target cell (e.g., the cell 163).

As shown in FIG. 5, the terminal device 110 may perform 501 downlink and uplink user data transmission with the CU 141 via the DU 151. In some scenarios, the DU 151 may make 502 a decision of a group handover to the DU 153. In this case, the DU 151 may transmit 503, to the CU 142, an UL RRC MESSAGE TRANSFER message via the CU 141. The CU 142 may transmit 504, to the DU 153, a UE CONTEXT SETUP REQUEST message comprising conditional inter-DU mobility information. The DU 153 may transmit 505, to the CU 142, a UE CONTEXT SETUP RESPONSE message comprising a requested target cell ID. The CU 142 may transmit 506, to the DU 151 via the CU 141, a DL RRC MESSAGE TRANSFER message comprising an RRCReconfiguration message.

The DU 151 may transmit 507, to a group of terminal devices (e.g., the terminal device 110), an RRCReconfiguration message comprising a configuration of a group handover command. This step 507 corresponds to step 310 as described in FIG. 3, and thus is not repeated here for concise. The terminal device 110 may transmit 508 an RRCReconfigurationComplete message to the DU 151. This step 508 corresponds to step 320 as described in FIG. 3, and thus is not repeated here for concise.

The DU 151 may perform 509 an early status transfer to the DU 153. The DU 151 may determine 510 to trigger a group handover. The DU 151 may transmit 511 a group handover command to the group of terminal devices. This step 511 corresponds to step 330 as described in FIG. 3, and thus is not repeated here for concise.

The terminal device 110 may apply 512 the stored configuration for the group handover command. This step 512 corresponds to step 340 as described in FIG. 3, and thus is not repeated here for concise.

Then the terminal device 110 may transmit 513 the acknowledgement for the group command to the DU 153. This step 513 corresponds to step 350 as described in FIG. 3, and thus is not repeated here for concise.

The DU 153 may transmit 514, to the CU 142, an UL RRC MESSAGE TRANSFER message comprising a handover complete message. The DU 153 may inform 515 the DU 151 of the handover success. The DU 151 may perform 516 a serial number (SN) status transfer to the DU 153. Then the terminal device 110 may perform 517 downlink and uplink user data transmission with the CU 142 via the DU 153.

It is to be understood that other details of the process 500 are similar to that of the process 300, and thus are omitted here.

With the process 500, a mechanism to acknowledge a handover command for a group of terminal devices in an inter-CU scenario is provided. As a resource for acknowledgement is preconfigured and is specific to a terminal device, signaling congestion may be avoided.

### Example Implementation of Methods

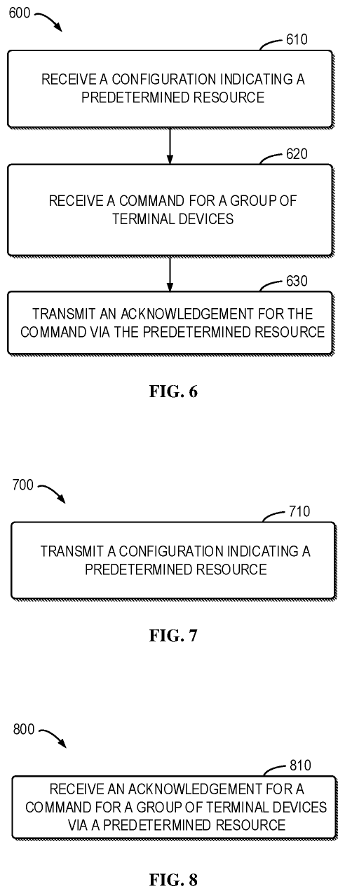

Accordingly, embodiments of the present disclosure provide methods of communication implemented at a terminal device and a network device. These methods will be described below with reference to FIGS. 6 to 8.

FIG. 6 illustrates an example method 600 of communication implemented at a terminal device in accordance with some embodiments of the present disclosure. For example, the method 600 may be performed at the terminal device 110 or 111 as shown in FIG. 1A. For the purpose of discussion, in the following, the method 600 will be described with reference to the terminal device 110 in FIG. 1A. It is to be understood that the method 600 may include additional blocks not shown and/or may omit some blocks as shown, and the scope of the present disclosure is not limited in this regard.

At block 610, the terminal device 110 receives, from the network device 120, a configuration indicating a predetermined resource for transmission of an acknowledgement for a command, the command being for a group of terminal devices comprising the terminal device 110.

In some embodiments, the predetermined resource may comprise at least one of the following: at least one of a preamble or a random access resource specific to the terminal device; a resource for a scheduling request; a resource for a physical uplink control channel transmission; a resource for a sounding reference signal; or a resource for a physical uplink shared channel transmission.

In some embodiments, the predetermined resource may be non-periodic or periodic. In some embodiments, the predetermine resource may be deactivated by default and activated when the command is received.

At block 620, the terminal device 110 receives the command from the network device 120.

In some embodiments, the terminal device 110 may receive a layer 1 or layer 2 signaling indicating the command. In some embodiments, the terminal device 110 may receive a short message indicating the command. In some embodiments, the terminal device 110 may receive a paging message indicating the command. In some embodiments, the terminal device 110 may receive a system information block indicating the command. In some embodiments, the terminal device 110 may receive a multicast or broadcast radio resource control signaling indicating the command. In some embodiments, the terminal device 110 may receive a low-power wake-up signal indicating the command. In some embodiments, the terminal device 110 may receive a paging early indication indicating the command.

At block 630, the terminal device 110 transmits, via the predetermined resource, the acknowledgement for the command.

In some embodiments, the terminal device 110 may transmit, as the acknowledgement, a preamble specific to the terminal device via the predetermined resource. In some embodiments, the terminal device 110 may transmit, as the acknowledgement, a scheduling request via the predetermined resource. In some embodiments, the terminal device 110 may transmit, as the acknowledgement, a positive acknowledgement or a negative acknowledgement via the predetermined resource. In some embodiments, the terminal device 110 may transmit, as the acknowledgement, a sounding reference signal via the predetermined resource. In some embodiments, the terminal device 110 may transmit, as the acknowledgement, a medium access control control element via the predetermined resource. In some embodiments, the terminal device 110 may transmit, as the acknowledgement, a radio resource control message via the predetermined resource.

In some embodiments, the command may indicate a handover of the group of terminal devices from a source cell provided by the network device 120 to a target cell provided by a further network device. In these embodiments, the terminal device 110 may transmit the acknowledgement to the further network device.

In some embodiments, the terminal device 110 may receive, from the network device 120, a further configuration for the handover, and perform the handover based on the further configuration. The further configuration may comprise at least one of the following: a set of candidate cells for the handover of the group of terminal devices; an indication indicating whether a random access procedure is performed for the handover to a candidate cell in the set of candidate cells; or an indication indicating whether an update of a security key is performed for the handover to the candidate cell.

In some embodiments where the command indicates the handover of the group of terminal devices, the command may comprise at least one of the following: an indication that the handover is triggered; information of the target cell; an indication indicating whether a timing advance value for the source cell is valid in the target cell; or an indication indicating whether an update of a security key is performed for the target cell.

In some embodiments, if the command is received, the terminal device 110 may start a timer configured for the handover.

In some embodiments, if the acknowledgement is transmitted or a message indicating a handover for the terminal device 110 is received, the terminal device 110 may stop the timer, and deactivate the predetermined resource. In some embodiments, the terminal device 110 may release a stored configuration. Alternatively, the terminal device 110 may not release the stored configuration.

In some embodiments, if the timer expires, the terminal device 110 may deactivate the predetermined resource, and apply a configuration used in the source cell. In some embodiments, the terminal device 110 may release a stored configuration. Alternatively, the terminal device 110 may not release the stored configuration.

In some embodiments, the network device 120 and the further network device are distributed units hosted by a same central unit. In some embodiments, the network device 120 and the further network device are distributed units hosted by different central units.

With the method of FIG. 6, a mechanism to acknowledge a command for a group of terminal devices is provided. As a resource for acknowledgement is preconfigured and is specific to a terminal device, signaling congestion may be avoided.

FIG. 7 illustrates an example method 700 of communication implemented at a network device in accordance with some embodiments of the present disclosure. For example, the method 700 may be performed at the network device 120 or 130 as shown in FIG. 1A. For the purpose of discussion, in the following, the method 700 will be described with reference to the network device 120 in FIG. 1A. It is to be understood that the method 700 may include additional blocks not shown and/or may omit some blocks as shown, and the scope of the present disclosure is not limited in this regard.

As shown in FIG. 7, at block 710, the network device 120 transmits, to a terminal device (e.g., the terminal device 110), a configuration indicating a predetermined resource for transmission of an acknowledgement for a command, the command being for a group of terminal devices comprising the terminal device 110.

In some embodiments, the predetermined resource may comprise at least one of the following: at least one of a preamble or a random access resource specific to the terminal device; a resource for a scheduling request; a resource for a physical uplink control channel transmission; a resource for a sounding reference signal; or a resource for a physical uplink shared channel transmission.

In some embodiments, the predetermined resource may be non-periodic or periodic. In some embodiments, the predetermine resource may be deactivated by default and activated when the command is received.

In some embodiments, the network device 120 may transmit the command to the group of terminal devices. In some embodiments, the network device 120 may transmit a layer 1 or layer 2 signaling indicating the command. In some embodiments, the network device 120 may transmit a short message indicating the command. In some embodiments, the network device 120 may transmit a paging message indicating the command. In some embodiments, the network device 120 may transmit a system information block indicating the command. In some embodiments, the network device 120 may transmit a multicast or broadcast radio resource control signaling indicating the command. In some embodiments, the network device 120 may transmit a low-power wake-up signal indicating the command. In some embodiments, the network device 120 may transmit a paging early indication indicating the command.

In some embodiments, the network device 120 may receive, via the predetermined resource, the acknowledgement for the command from the terminal device 110. In some embodiments, the network device 120 may receive, as the acknowledgement, a preamble specific to the terminal device via the predetermined resource. In some embodiments, the network device 120 may receive, as the acknowledgement, a scheduling request via the predetermined resource. In some embodiments, the network device 120 may receive, as the acknowledgement, a positive acknowledgement or a negative acknowledgement via the predetermined resource. In some embodiments, the network device 120 may receive, as the acknowledgement, a sounding reference signal via the predetermined resource. In some embodiments, the network device 120 may receive, as the acknowledgement, a medium access control control element via the predetermined resource. In some embodiments, the network device 120 may receive, as the acknowledgement, a radio resource control message via the predetermined resource.

In some embodiments, the command may indicate a handover of the group of terminal devices from a source cell provided by the network device to a target cell provided by a further network device. In these embodiments, the network device 120 may transmit, to the terminal device 110, a further configuration for the handover. The further configuration may comprise at least one of the following: a set of candidate cells for the handover of the group of terminal devices; an indication indicating whether a random access procedure is performed for the handover to a candidate cell in the set of candidate cells; or an indication indicating whether an update of a security key is performed for the handover to the candidate cell.

In some embodiments where the command indicates the handover of the group of terminal devices, the command may comprise at least one of the following: an indication that the handover is triggered; information of the target cell; an indication indicating whether a timing advance value for the source cell is valid in the target cell; or an indication indicating whether an update of a security key is performed for the target cell.

In some embodiments, the network device and the further network device are distributed units hosted by a same central unit. In some embodiments, the network device and the further network device are distributed units hosted by different central units.

With the method of FIG. 7, a mechanism to acknowledge a command for a group of terminal devices is provided. As a resource for acknowledgement is preconfigured and is specific to a terminal device, signaling congestion may be avoided.

FIG. 8 illustrates another example method 800 of communication implemented at a network device in accordance with some embodiments of the present disclosure. For example, the method 800 may be performed at the network device 120 or 130 as shown in FIG. 1A. For the purpose of discussion, in the following, the method 800 will be described with reference to the network device 130 in FIG. 1A. It is to be understood that the method 800 may include additional blocks not shown and/or may omit some blocks as shown, and the scope of the present disclosure is not limited in this regard.

As shown in FIG. 8, at block 810, the network device 130 receives, from a terminal device (e.g., the terminal device 110), an acknowledgement for a command via a predetermined resource for the acknowledgement, the command being for a group of terminal devices comprising the terminal device 110 and indicating a handover of the group of terminal devices to a target cell provided by the network device 130.

In some embodiments, the network device 130 may receive, as the acknowledgement, a preamble specific to the terminal device 110 via the predetermined resource. In some embodiments, the network device 130 may receive, as the acknowledgement, a scheduling request via the predetermined resource. In some embodiments, the network device 130 may receive, as the acknowledgement, a positive acknowledgement or a negative acknowledgement via the predetermined resource. In some embodiments, the network device 130 may receive, as the acknowledgement, a sounding reference signal via the predetermined resource. In some embodiments, the network device 130 may receive, as the acknowledgement, a medium access control control element via the predetermined resource. In some embodiments, the network device 130 may receive, as the acknowledgement, a radio resource control message via the predetermined resource.

With the method of FIG. 8, a mechanism to acknowledge a command for a group of terminal devices is provided. As a resource for acknowledgement is preconfigured and is specific to a terminal device, signaling congestion may be avoided.

### Example Implementation of Devices

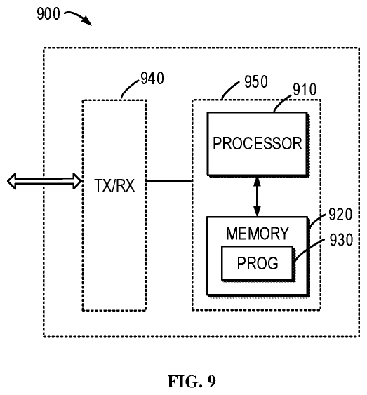

FIG. 9 illustrates a simplified block diagram of a device 900 that is suitable for implementing embodiments of the present disclosure. The device 900 can be considered as a further example implementation of the terminal device 110 or 111 or the network device 120 or 130 as shown in FIG. 1. Accordingly, the device 900 can be implemented at or as at least a part of the terminal device 110 or 111 or the network device 120 or 130.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to: receive, from a network device, a configuration indicating a predetermined resource for transmission of an acknowledgement for a command, the command being for a group of terminal devices comprising the terminal device; receive the command from the network device; and transmit, via the predetermined resource, the acknowledgement for the command.

In some embodiments, a network device comprises a circuitry configured to: transmit, to a terminal device, a configuration indicating a predetermined resource for transmission of an acknowledgement for a command, the command being for a group of terminal devices comprising the terminal device.

In some embodiments, a network device comprises a circuitry configured to: receive, from a terminal device, an acknowledgement for a command via a predetermined resource for the acknowledgement, the command being for a group of terminal devices comprising the terminal device and indicating a handover of the group of terminal devices to a target cell provided by the network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device and from a network device, a configuration indicating a predetermined resource for transmission of an acknowledgement for a command, the command being for a group of terminal devices comprising the terminal device; receiving the command from the network device; and transmitting, via the predetermined resource, the acknowledgement for the command.

In some embodiments, the predetermined resource comprises at least one of the following: at least one of a preamble or a random access resource specific to the terminal device; a resource for a scheduling request; a resource for a physical uplink control channel transmission; a resource for a sounding reference signal; or a resource for a physical uplink shared channel transmission.

In some embodiments, the predetermined resource is non-periodic or periodic, and the predetermine resource is deactivated by default and is activated when the command is received.

In some embodiments, receiving the command comprises at least one of the following: receiving a layer 1 or layer 2 signaling indicating the command; receiving a short message indicating the command; receiving a paging message indicating the command; receiving a system information block indicating the command; receiving a multicast or broadcast radio resource control signaling indicating the command; receiving a low-power wake-up signal indicating the command; or receiving a paging early indication indicating the command.

In some embodiments, transmitting the acknowledgement comprises at least one of the following: transmitting, as the acknowledgement, a preamble specific to the terminal device via the predetermined resource; transmitting, as the acknowledgement, a scheduling request via the predetermined resource; transmitting, as the acknowledgement, a positive acknowledgement or a negative acknowledgement via the predetermined resource; transmitting, as the acknowledgement, a sounding reference signal via the predetermined resource; transmitting, as the acknowledgement, a medium access control control element via the predetermined resource; or transmitting, as the acknowledgement, a radio resource control message via the predetermined resource.

In some embodiments, the command indicates a handover of the group of terminal devices from a source cell provided by the network device to a target cell provided by a further network device. In these embodiments, transmitting the acknowledgement comprises: transmitting the acknowledgement to the further network device.

In some embodiments, the method above further comprises: receiving, from the network device, a further configuration for the handover; and performing the handover based on the further configuration. The further configuration comprises at least one of the following: a set of candidate cells for the handover of the group of terminal devices; an indication indicating whether a random access procedure is performed for the handover to a candidate cell in the set of candidate cells; or an indication indicating whether an update of a security key is performed for the handover to the candidate cell.

In some embodiments, the command comprises at least one of the following: an indication that the handover is triggered; information of the target cell; an indication indicating whether a timing advance value for the source cell is valid in the target cell; or an indication indicating whether an update of a security key is performed for the target cell.

In some embodiments, the method above further comprises: in accordance with a determination that the command is received, starting a timer configured for the handover.

In some embodiments, the method above further comprises: in accordance with a determination that the acknowledgement is transmitted or a message indicating a handover for the terminal device is received, stopping the timer; and deactivating the predetermined resource.

In some embodiments, the method above further comprises: in accordance with a determination that the timer expires, deactivating the predetermined resource; and applying a configuration used in the source cell.

In some embodiments, the method above further comprises: releasing a stored configuration; or not releasing the stored configuration.

In some embodiments, the network device and the further network device are distributed units hosted by a same central unit, or the network device and the further network device are distributed units hosted by different central units.

In another solution, a method of communication comprises: transmitting, at a network device and to a terminal device, a configuration indicating a predetermined resource for transmission of an acknowledgement for a command, the command being for a group of terminal devices comprising the terminal device.

In some embodiments, the predetermined resource comprises at least one of the following: at least one of a preamble or a random access resource specific to the terminal device; a resource for a scheduling request; a resource for a physical uplink control channel transmission; a resource for a sounding reference signal; or a resource for a physical uplink shared channel transmission.

In some embodiments, the predetermined resource is non-periodic or periodic, and the predetermine resource is deactivated by default and is activated when the command is received.

In some embodiments, the method above further comprises: transmitting the command to the group of terminal devices.

In some embodiments, transmitting the command comprises at least one of the following: transmitting a layer 1 or layer 2 signaling indicating the command; transmitting a short message indicating the command; transmitting a paging message indicating the command; transmitting a system information block indicating the command; transmitting a multicast or broadcast radio resource control signaling indicating the command; transmitting a low-power wake-up signal indicating the command; or transmitting a paging early indication indicating the command.

In some embodiments, the method above further comprises: receiving, via the predetermined resource, the acknowledgement for the command from the terminal device.

In some embodiments, receiving the acknowledgement comprises at least one of the following: receiving, as the acknowledgement, a preamble specific to the terminal device via the predetermined resource; receiving, as the acknowledgement, a scheduling request via the predetermined resource; receiving, as the acknowledgement, a positive acknowledgement or a negative acknowledgement via the predetermined resource; receiving, as the acknowledgement, a sounding reference signal via the predetermined resource; receiving, as the acknowledgement, a medium access control control element via the predetermined resource; or receiving, as the acknowledgement, a radio resource control message via the predetermined resource.

In some embodiments, the command indicates a handover of the group of terminal devices from a source cell provided by the network device to a target cell provided by a further network device.

In some embodiments, the method above further comprises: transmitting, to the terminal device, a further configuration for the handover, the further configuration comprising at least one of the following: a set of candidate cells for the handover of the group of terminal devices; an indication indicating whether a random access procedure is performed for the handover to a candidate cell in the set of candidate cells; or an indication indicating whether an update of a security key is performed for the handover to the candidate cell.

In some embodiments, the command comprises at least one of the following: an indication that the handover is triggered; information of the target cell; an indication indicating whether a timing advance value for the source cell is valid in the target cell; or an indication indicating whether an update of a security key is performed for the target cell.

In some embodiments, the network device and the further network device are distributed units hosted by a same central unit, or the network device and the further network device are distributed units hosted by different central units.

In another solution, a method of communication comprises: receiving, at a network device and from a terminal device, an acknowledgement for a command via a predetermined resource for the acknowledgement, the command being for a group of terminal devices comprising the terminal device and indicating a handover of the group of terminal devices to a target cell provided by the network device.

In some embodiments, receiving the acknowledgement comprises at least one of the following: receiving, as the acknowledgement, a preamble specific to the terminal device via the predetermined resource; receiving, as the acknowledgement, a scheduling request via the predetermined resource; receiving, as the acknowledgement, a positive acknowledgement or a negative acknowledgement via the predetermined resource; receiving, as the acknowledgement, a sounding reference signal via the predetermined resource; receiving, as the acknowledgement, a medium access control control element via the predetermined resource; or receiving, as the acknowledgement, a radio resource control message via the predetermined resource.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
receiving, at a terminal device and from a network device, a configuration indicating a predetermined resource for transmission of an acknowledgement for a command, the command being for a group of terminal devices comprising the terminal device;
receiving the command from the network device; and
transmitting, via the predetermined resource, the acknowledgement for the command.

2. The method of claim 1, wherein the predetermined resource comprises at least one of the following:
at least one of a preamble or a random access resource specific to the terminal device;
a resource for a scheduling request;
a resource for a physical uplink control channel transmission;
a resource for a sounding reference signal; or
a resource for a physical uplink shared channel transmission.

3. The method of claim 1, wherein the predetermined resource is non-periodic or periodic, and
wherein the predetermine resource is deactivated by default and is activated when the command is received.

4. The method of claim 1, wherein receiving the command comprises at least one of the following:
receiving a layer 1 or layer 2 signaling indicating the command;
receiving a short message indicating the command;
receiving a paging message indicating the command;
receiving a system information block indicating the command;
receiving a multicast or broadcast radio resource control signaling indicating the command;
receiving a low-power wake-up signal indicating the command; or
receiving a paging early indication indicating the command.

5. The method of claim 1, wherein transmitting the acknowledgement comprises at least one of the following:
transmitting, as the acknowledgement, a preamble specific to the terminal device via the predetermined resource;
transmitting, as the acknowledgement, a scheduling request via the predetermined resource;
transmitting, as the acknowledgement, a positive acknowledgement or a negative acknowledgement via the predetermined resource;
transmitting, as the acknowledgement, a sounding reference signal via the predetermined resource;
transmitting, as the acknowledgement, a medium access control control element via the predetermined resource; or
transmitting, as the acknowledgement, a radio resource control message via the predetermined resource.

6. The method of claim 1, wherein the command indicates a handover of the group of terminal devices from a source cell provided by the network device to a target cell provided by a further network device, and wherein transmitting the acknowledgement comprises:
transmitting the acknowledgement to the further network device.

7. The method of claim 6, further comprising:
receiving, from the network device, a further configuration for the handover; and
performing the handover based on the further configuration, the further configuration comprising at least one of the following:
a set of candidate cells for the handover of the group of terminal devices;
an indication indicating whether a random access procedure is performed for the handover to a candidate cell in the set of candidate cells; or
an indication indicating whether an update of a security key is performed for the handover to the candidate cell.

8. The method of claim 6, wherein the command comprises at least one of the following:
an indication that the handover is triggered;
information of the target cell;
an indication indicating whether a timing advance value for the source cell is valid in the target cell; or
an indication indicating whether an update of a security key is performed for the target cell.

9. The method of claim 6, further comprising:
in accordance with a determination that the command is received, starting a timer configured for the handover.

10. The method of claim 9, further comprising:
in accordance with a determination that the acknowledgement is transmitted or a message indicating a handover for the terminal device is received,
stopping the timer; and
deactivating the predetermined resource.

11. The method of claim 9, further comprising:
in accordance with a determination that the timer expires,
deactivating the predetermined resource; and
applying a configuration used in the source cell.

12. The method of claim 10, further comprising:
releasing a stored configuration; or
not releasing the stored configuration.

13. The method of claim 6, wherein the network device and the further network device are distributed units hosted by a same central unit, or
wherein the network device and the further network device are distributed units hosted by different central units.

14. A method of communication, comprising:
transmitting, at a network device and to a terminal device, a configuration indicating a predetermined resource for transmission of an acknowledgement for a command, the command being for a group of terminal devices comprising the terminal device.

15. The method of claim 14, wherein the predetermined resource comprises at least one of the following:
at least one of a preamble or a random access resource specific to the terminal device;
a resource for a scheduling request;
a resource for a physical uplink control channel transmission;
a resource for a sounding reference signal; or
a resource for a physical uplink shared channel transmission.

16. The method of claim 14, wherein the predetermined resource is non-periodic or periodic, and
wherein the predetermine resource is deactivated by default and is activated when the command is received.

17. The method of claim 14, further comprising:
transmitting the command to the group of terminal devices.

18. The method of claim 17, wherein transmitting the command comprises at least one of the following:
transmitting a layer 1 or layer 2 signaling indicating the command;
transmitting a short message indicating the command;
transmitting a paging message indicating the command;
transmitting a system information block indicating the command;
transmitting a multicast or broadcast radio resource control signaling indicating the command;
transmitting a low-power wake-up signal indicating the command; or
transmitting a paging early indication indicating the command.

19. The method of claim 17, wherein the command indicates a handover of the group of terminal devices from a source cell provided by the network device to a target cell provided by a further network device.

20. A method of communication, comprising:
receiving, at a network device and from a terminal device, an acknowledgement for a command via a predetermined resource for the acknowledgement, the command being for a group of terminal devices comprising the terminal device and indicating a handover of the group of terminal devices to a target cell provided by the network device.
